(19) United States
(12) Patent Application Publication
(10) Pub. No.: US 2026/0285156 A1
(43) Pub. Date: Sep. 24, 2026

(54) Vehicle Windshield With a Switchable Black Printed Area, and a HUD, Which Can Be Used From the Interior and the Exterior, for a Vehicle

(71) Applicant: Bayerische Motoren Werke Aktiengesellschaft, Muenchen (DE)

(72) Inventors: Yannick FORSTER, Muenchen (DE); Sebastian HERGETH, Muenchen (DE)

(21) Appl. No.: 19/475,541

(22) PCT Filed: Jun. 25, 2024
(86) PCT No.: PCT/DE2024/100561

§ 371 Date: Oct. 15, 2025

(30) Foreign Application Priority Data
Jul. 11, 2023 (DE) 10 2023 118 320.6

(51) Int. Cl. B60K 35/29; B60J 1/02; B60J 1/18; B60K 35/231; B60K 35/60; B60K 35/81; B60Q 1/50; G02B 27/01

(52) U.S. Cl. CPC B60K 35/29; B60J 1/02; B60J 1/18; B60K 35/231; B60K 35/60; B60K 35/81; B60Q 1/5035; G02B 27/0101; B60K 2360/27; B60K 2360/31; B60K 2360/785

(57) ABSTRACT

A vehicle windshield is configured to be installed into a vehicle as its front windshield or rear windshield. The vehicle windshield includes a black or darkly printed, colored, or tinted combiner film which extends within or on the vehicle windshield in the lower surface region thereof. The entire combiner film and/or its predefined surface segments are configured to be electrically or mechanically switchable between a substantially opaque black printed state and a semi-transparent exterior visibility state.

### BACKGROUND AND SUMMARY

The invention relates to a vehicle windshield which is designed for installation in a motor vehicle or other land craft, aircraft or watercraft as its front or rear windshield and which is printed, dyed or tinted in black or dark in the lower surface region. The invention also relates to a vehicle equipped with it and a field of view display device, also known as a head-up display (HUD), for use in that vehicle. It is used to generate a virtual image superimposed on the field of view of at least one vehicle occupant by reflection on the mentioned vehicle windshield. The invention also relates to an associated operating method and a correspondingly configured control unit.

With a head-up display, for example, speed information and other useful navigation, warning and vehicle operating information or entertainment content can be displayed to the driver and/or another occupant in the form of a virtual image when looking into the windscreen. Among other things, a simplified HUD design with an imager is known for the generation of a panorama-like virtual display, which is positioned in a bottom pane area of the windshield in such a way that the real image generated by it is reflected directly on the windshield without further imaging or deflection optics in between. Such an imager is therefore also known as a “windshield root display”.

For a particularly high-contrast display that is largely independent of the ambient brightness, it is sometimes suggested in the prior art for a HUD in the vehicle to use a so-called “black print area” at the lower edge of the front windscreen for the HUD display. In contrast to the transparent area of the front windscreen above, this is printed, dyed or tinted black or dark and serves, among other things, to conceal the view under the hood of the occupants.

Furthermore, it is, for example, known from DE 10 2017 219 737 A1 and DE 10 2021 126 193 A1 to use a head-up display in a motor vehicle not only to overlay content in the field of view of an occupant, but also alternatively to display information that is visible from outside the vehicle when the vehicle is parked.

It is an object of the present invention to specify an alternative and/or improved design and use concept for a front or rear windshield of a vehicle with regard to the use of the above-mentioned “black print area”. It is also an object of the present invention to specify a field of view display device designed to overlay a virtual image in the field of view of at least one occupant by reflection on this front windshield. The vehicle windshield can be particularly suitable for a panorama-like virtual image display for one or more vehicle occupants.

These objects are achieved by a vehicle windshield, by a field of view display device containing it and a vehicle equipped with it, and by an associated operating method and a correspondingly configured control unit according to the claimed invention. The further features and effects referred to in the claims and the description below for the vehicle windshield shall also apply in respect of the field of view display device, the vehicle, the method and the control unit, and vice versa.

According to a first aspect, a vehicle windshield is envisaged that is designed to be installed in a vehicle as its front or rear windshield. The vehicle can be a motor vehicle, but also any other land, air or water vehicle. The vehicle windshield in question comprises a black or dark printed, dyed or tinted combiner film that extends inside or on the vehicle windshield in its lower surface region when installed in the vehicle. The entire combiner film and/or the predetermined surface segments thereof are electrically or mechanically switchable between a largely opaque black print state and at least one semi-transparent (for example translucent and diffusely light-scattering or largely transparent) externally visible state. For example, but not necessarily, the combiner film can be designed to be switchable between multiple externally visible states with different degrees of transparency.

In the black print state, the combiner film thus forms the “black print area” of the vehicle windshield mentioned at the beginning, which can be used, for example, for a field of view display device for a particularly high-contrast overlay of display content into the field of view of one or more vehicle occupants that is independent of the ambient brightness.

One idea is to switch this black print region to at least partially translucent in situations where it is not needed (for example, because there is no one in the vehicle) in order to transport certain information from the vehicle to the outside. The combiner film is made semi-transparent by a technical intervention, such as mechanical shifting of the combiner film or the application of electrical voltage to it, etc. For example, for switching by electrical voltage, the combiner film can be formed with well-known electrochromic materials.

According to one embodiment, the combiner film is divided into surface segments which can be selectively switched mutually independently between the black print state and the at least one externally visible state. This allows the black print to be removed depending on the location. This can save the required switching energy and/or highlight the externally visible information and/or maintain the opaque coverage required in other areas.

According to another aspect, a field of view display device is provided for use in the mentioned vehicle for the purpose of overlaying a virtual image in the field of view of at least one occupant by reflection on the mentioned vehicle windshield. Accordingly, the field of view display device contains this vehicle windshield and a projection unit which is designed to generate and output a light beam with the desired display content and in a predetermined shape and direction to this vehicle windshield and at least partly in its surface region with the switchable combiner film. For example, the field of view display device can be in the form of a head-up display (HUD).

Here the vehicle windshield is arranged and shaped in the field of view of the at least one occupant in such a way that it reflects the light beam to a spatial area (eyebox) within the vehicle that is predetermined for his eyes, whereby the display content can be displayed to him in the form of a virtual image. Furthermore, the projection unit is designed to generate the light beam, with the vehicle in a parked and/or abandoned and/or switched off state, with display content intended for an external observer and to direct it to the surface region of the vehicle windshield in which the combiner film is switched to one of the external visibility states thereof so that this display content is visible from outside the vehicle.

For example, the combiner film can be switched to a light-diffusing externally visibility state and the projection unit can be designed to project a real image onto the surface region of the vehicle windshield, when the vehicle is in the parked and/or abandoned and/or switched off state, in which the combiner film is switched to this externally visible state, so that this real image is visible to observers outside the vehicle. In other words, the light beam is focused on the combiner film as a light-scattering projection surface, and the real image is generated in it. For this purpose, suitable imaging optics may be provided in the projection unit.

Alternatively or additionally, the combiner film can be switched to an externally visible state that is largely transparent to the light beam (i.e. as far as possible without light scattering, but minus the parts reflected on the inside of the vehicle) and the projection unit can be designed, when the vehicle is in the parked and/or abandoned and/or switched off state, to direct the light beam to the surface region of the vehicle windshield in which the combiner film is switched to this externally visible state and the light beam is therefore transmitted largely undistorted. As a result, the display content generated in the projection unit is visible from outside the vehicle through this surface region.

According to one embodiment, an image-generating surface of the projection unit is arranged directly opposite the vehicle windshield, with the exception of any covers of the projection unit (for example, in the form of a cover plate that allows the light beam to pass through), which have no beam shaping, deflecting or imaging optical effect on the light beam. In other words, the field of view display device does not include any other optical elements such as deflection mirrors or concave mirrors or lenses, etc. in the optical path of the light beam between the image-generating surface and the vehicle windshield. However, optical coatings are still possible. In particular, a projection unit that is compact in the height direction can be implemented, which is therefore particularly suitable for a large area and/or panorama-like display.

According to another aspect, a method for switching off the black print in the mentioned vehicle windshield in a vehicle is envisaged. Switching off the black print always requires the determination of a parked and/or abandoned and/or switched off state of the vehicle.

If this is the case, then in a first variant of the method, the recognition of at least one object or item that is placed or formed on an instrument panel or parcel shelf of the vehicle and is concealed from observers outside the vehicle by the combiner film in its black print state can be used as a trigger for switching the combiner film into an externally visible state at least in a correspondingly specified surface segment. This allows this object or item to be made visible from outside the vehicle. Items that are wanted to be made visible in this way can be, for example, a parking ticket, a parking disc, a bunch of keys, a mobile phone and much more.

Detection of stored items can be realized with any suitable sensor technology in the area of the instrument panel/parcel shelf, for example by way of infrared, ultrasonic, pressure, brightness and/or capacitive area detection. From these sensor data, the respective item can be recognized or detected and, based on this, a required surface segment of the combiner film can be determined.

In the case of an alternative or additional method variant, display content intended for at least one observer outside the vehicle (for example the display of a parking disc or certain vehicle displays such as its state of charge, etc.) can be provided and the combiner film can be switched to an externally visible state at least in a surface segment predetermined for this. Here the projection unit is controlled for generating and emitting the light beam with this display content towards this surface segment of the combiner film, so that this display content is visible from outside the vehicle as described above.

According to another aspect, a control unit is envisaged that is designed and set up to carry out this method automatically. For this purpose, for example, a corresponding computer program (software) can be loaded into a processor of the control unit and run during the operation of the vehicle.

According to another aspect the above-mentioned vehicle is envisaged. The spatial orientation terms used herein, such as “upper”, “lower”, “horizontal”, “vertical” etc. refer to the usual vehicle-fixed Cartesian coordinate system with mutually perpendicular longitudinal, transverse and elevation axes of the vehicle. The vehicle has the vehicle windshield presented herein as the front or rear windshield thereof. In particular, it can also be equipped with the above field of view display device. In particular, the above control unit may also be provided in the vehicle.

According to one embodiment, the vehicle also contains an instrument panel or parcel shelf, which extends inside the vehicle below the mentioned vehicle windshield. The combiner film, measured along the windshield surface of the mentioned vehicle windshield perpendicular to its lower edge, has such a width that a surface region of the instrument panel or parcel shelf adjacent to the vehicle windshield is concealed by the combiner film in its black print state from observers outside the vehicle. Purely as an example, the width mentioned can be at least 5 cm or even at least 10 cm, measured inside the vehicle from the root of the windshield.

The above aspects of the invention and its embodiments and specific configurations are explained in more detail below by way of examples shown in the attached drawings. The drawings are purely schematic, i.e. not to be understood as true to scale.

### BRIEF DESCRIPTION OF THE DRAWINGS

FIG. 1 shows a section of a vehicle with a field of view display device according to an exemplary embodiment of the invention in a vertical longitudinal section with a schematic representation of the optical path.

FIG. 2 shows an external top view of a windscreen of a parked vehicle according to an exemplary embodiment of the invention, wherein a combiner film serving as a black print is switched to transparent in individual areas.

### DETAILED DESCRIPTION OF THE DRAWINGS

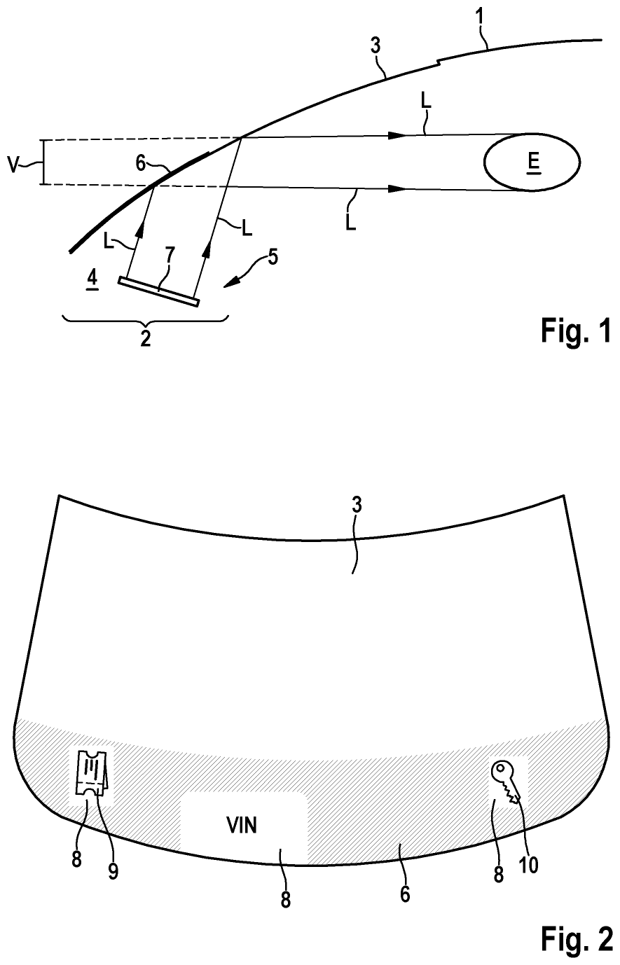

All further various embodiments, alternatives and specific design features of the vehicle windshield, of the field of view display device, the operating method, the control unit and the vehicle according to the above aspects of the invention mentioned above in the description and in the claims below can be implemented in the examples shown in FIGS. 1 and 2, in particular also alternatively or in addition to the features shown therein. They will therefore not all be repeated below. The same applies mutatis mutandis to the definitions of terms and effects already given above in relation to individual features which are shown in FIGS. 1-2.

FIG. 1 shows in a highly simplified vertical longitudinal representation a section of a vehicle 1 with a field of view display device 2 according to an exemplary embodiment of the invention. The spatial orientation terms used below, such as “horizontal”, “vertical”, “below”, “above”, etc., refer to the usual vehicle-fixed cartesian coordinate system with mutually perpendicular longitudinal, transverse and elevation directions of the vehicle 1.

In this example, the vehicle 1 is a motor vehicle, which is indicated in FIG. 1 only by its vehicle windshield 3 (here a front windshield), which also serves as part of the field of view display device 2. Below this, a projection unit 5 of the field of view display device 2 is arranged in an instrument panel 4 of the vehicle 1 that is not shown in detail.

The vehicle windshield 3 is equipped with a black or dark printed, dyed or tinted combiner film 6, which extends inside or on the surface of the vehicle windshield 3 in its lower surface region. The entire combiner film 6 and/or the predetermined surface segments thereof are designed to be electrically or mechanically switchable between a largely opaque black print state and a semi-transparent, in this example largely transparent, externally visible state.

The field of view display device 2 is designed, among other things, to generate a virtual image V in the field of view of at least one vehicle occupant. It is a head-up display (HUD) purely as an example. The mentioned occupant is indicated in FIG. 1 only by an eyebox E intended for his eyes in the interior of the vehicle 1 and may be, for example, a driver and/or a front passenger of the vehicle 1.

For this purpose, the projection unit 5 contains an image-generating surface 7, in which a desired display content is generated as a real image. The image-generating surface 7 can be, for example, a display surface or a projection screen of a projector-based imager. The projection unit 5 is designed to output a light beam L transporting this display content in a suitable form and direction to the vehicle windshield 3 and at least partially in its surface region with the switchable combiner film 6. In this example, the image-generating surface 7 is arranged directly opposite the vehicle windshield 3 without any further imaging or projection optics in between. In particular, the field of view display device 2 can be designed for a panorama-like virtual representation wherein the vehicle windshield 3 and the switchable combiner film 6 thereof are used to reflect the light beam L with their almost entire horizontal extent. For the virtual image display for the vehicle occupants, the combiner film 6 can be switched to its black print state in order to display the virtual image V with high contrast even in broad daylight.

Furthermore, with the vehicle 1 in a parked and/or abandoned and/or switched off state, the projection unit 5 is designed to produce the light beam L with a display content intended for external observers and to direct it at the surface region of the vehicle windshield 3 in which the combiner film 6 is switched to its externally visible state, so that this display content is visible from outside the vehicle 1. In this way, useful information can be transported to the outside, for example by displaying a parking ticket or a parking disc externally visibly in the black print area of the vehicle windscreen 3 using the same HUD technology.

FIG. 2 shows a top outside view of a front windshield 3 of a parked vehicle 1 according to an exemplary embodiment of the invention. It can be the vehicle 1 of FIG. 1 purely as an example, so that in order to avoid repetition, reference is made to the above description of the vehicle windshield 3 of FIG. 1.

As an alternative to the outside HUD representation described above, the field of view display device 2 may also be switched off or missing in the parked vehicle 1 of FIG. 2. Instead, the vehicle 1 or a control unit provided therein (not shown) may be designed to recognize items placed or objects formed on the instrument panel 4 which are concealed from observers outside the vehicle 1 by the combiner film 6 in its black print state (indicated in hatched form in FIG. 2). This is used in FIG. 2 as a trigger for switching the combiner film 6 to a transparent externally visible state in correspondingly specified surface segments 8. Such items or objects can be recognized with any suitable sensor technology, which can be based, for example, on infrared, ultrasonic, pressure, brightness and/or capacitive detection. From this, the required surface segments 8 of the combiner film 6 can be determined.

The items/objects that have been made externally visible in this way are in FIG. 2 merely by way of example a parking ticket 9, a vehicle identification number VIN stamped in the instrument panel 4 or a carrier and a key 10.

### LIST OF REFERENCE SIGNS

1 Vehicle
2 Field of view display device
3 Vehicle windshield
4 Instrument panel
5 Projection unit
6 Switchable combiner film
7 Image-generating surface
8 Surface segments in the external visibility state
9 Parking ticket
10 Key
Light beam with display content, also called projector light
Eyebox
V Virtual image

1.-10. (canceled)

11. A vehicle windshield for installation in a vehicle as a front windshield or a rear windshield, the vehicle windshield comprising:
a black or dark printed, dyed or tinted combiner film extending inside or on the vehicle windshield in its lower surface region when installed in the vehicle;
wherein the entire combiner film and/or predetermined surface segments of the combiner film are electrically or mechanically switchable between an essentially opaque black print state and at least one semi-transparent external visibility state.

12. The vehicle windshield according to claim 11, wherein
the combiner film is divided into surface segments, each of which can be switched mutually independently and selectively between the black print state and the at least one semi-transparent external visibility state.

13. A field of view display device for the vehicle for overlaying a virtual image in a field of view of at least one occupant, the field of view display device comprising:
the vehicle windshield according to claim 11 arranged in the field of view of the at least one occupant; and
a projection unit, which is configured to generate and output a light beam with desired display content and in a predetermined shape and direction to the vehicle windshield and thereby at least partially in a surface segment thereof with the combiner film;
wherein the vehicle windshield is arranged and configured in the field of view of the at least one occupant such that the vehicle windshield reflects the light beam to an eyebox predetermined for eyes of the at least one occupant, whereby the display content can be displayed to the at least one occupant in a form of the virtual image beyond the vehicle windshield; and
wherein the projection unit is configured to generate the light beam when the vehicle is in a parked and/or abandoned and/or switched off state with the display content intended for an observer outside the vehicle and to direct the light beam to a first surface region of the vehicle windshield in which the combiner film is switched to a first one of the external visibility states, so that the display content is visible from outside the vehicle.

14. The field of view display device according to claim 13, wherein
the combiner film is light-diffusing in at least a second one of the external visibility states; and
the projection unit is configured to project a real image on a second surface region of the vehicle windshield in which the combiner film is switched to the second one of the externally visible states when the vehicle is in the parked and/or abandoned and/or switched off state, so that the real image is visible to the observer outside the vehicle.

15. The field of view display device according to claim 13, wherein
the combiner film is largely transparent to the light beam in at least a third one of the external visibility states; and
the projection unit is configured to direct the light beam at a third surface region of the vehicle windshield in which the combiner film is switched to the third external visibility state, when the vehicle is in the parked and/or abandoned and/or switched off state, so that the display content generated in the projection unit is visible from outside the vehicle through the third surface region.

16. The field of view display device according to claim 13,
wherein an image-generating surface of the projection unit is arranged directly opposite the vehicle windshield, with the exception of any covers of the projection unit which have no beam shaping, beam deflecting or imaging optical effect on the light beam.

17. A method for switching off black printing in the field of view display device according to claim 13, the method comprising:
determining a parked and/or abandoned and/or switched off state of the vehicle;
recognizing at least one item or object which lies or is formed on an instrument panel or parcel shelf of the vehicle and is concealed from observers outside the vehicle by the combiner film in the black print state; and switching the combiner film to a first one of the external visibility states at least in a correspondingly determined surface segment, so that the at least one item or object is visible to the observers; and/or
providing display content intended for at least one viewer outside the vehicle; switching the combiner film to a second one of the external visibility states, at least in a surface segment predetermined for this purpose; and controlling the projection unit for generating and emitting the light beam with this display content towards the combiner film that is switched to the second one of the external visibility states, so that the display content is presented to the at least one viewer outside the vehicle as a real or virtual image.

18. A control unit which is configured for automatic execution of the method according to claim 17.

19. A motor vehicle with mutually perpendicular longitudinal, transverse and elevation directions of a Cartesian coordinate system fixed relative to the vehicle, the motor vehicle comprising:
the field of view display device according to claim 13.

20. The vehicle according to claim 19, further comprising:
an instrument panel or a parcel shelf, which extends within the vehicle interior below the vehicle windshield;
wherein the combiner film, measured along a pane surface and perpendicular to a lower edge of the vehicle windshield, has such a width that a surface region of the instrument panel or the parcel shelf adjacent to the vehicle windshield is concealed from observers outside the vehicle by the combiner film in the black print state.
